(19) United States
(12) Patent Application Publication
(10) Pub. No.: US 2008/0063217 A1
(43) Pub. Date: Mar. 13, 2008

(54) ASSEMBLY ON A MOTOR-BICYCLE

(76) Inventor: PETER KUAN, Taipei City (TW)

Correspondence Address: LEONG C LEI, PMB # 1008, 1867 YGNACIO VALLEY ROAD, WALNUT CREEK, CA, 94598, US

(21) Appl. No.: 11/849,366

(22) Filed: Sep. 4, 2007

(30) Foreign Application Priority Data
Sep. 8, 2006 (TW) 095216189

(51) Int. Cl. H04B 1/00

(52) U.S. Cl. 381/86

(57) ABSTRACT

A music-playing assembly on a motor-bicycle. The assembly comprises a digital music-playing device, a controlling device and at least one loudspeaker characterized in that the digital music-playing device is mounted at the rear mirror of the motor-bicycle and is connected to the controlling device and the loudspeaker via transmission lines, the controlling device is used to control the digital music-playing device and the loudspeaker to play or produce music. The cyclist can control the music-playing of music while his hands are on the handle.

### BACKGROUND OF THE INVENTION

(a) Technical Field of the Invention

The present invention relates to music-playing assembly, and in particular, an assembles used to play music or the like which is controlled by the cyclist while he is cycling.

(b) Description of the Prior Art

Digital music-playing device such as MP3 employed third generation sound compression format and have a thin, large capacity song selection and portability advantages that the MP3 are not replacing CD players.

Modern digital music-playing device has a housing containing memory device stored with music and songs, and circuit. The external side of the housing is provided with buttons and a port for an ear piece.

In application, the ear piece is plugged into the port and the loudspeaker of the ear piece are inserted to the ear of the wearer. However, for a cyclist while cycling, it is not possible for the cyclist to adjust the volume or select songs without removing his hands from the motor-bicycle handle. It is risky to cycle while performing the song selection on a MP3. Accordingly, it is an object of the present invention to provide an assembly on a motor-bicycle which mitigate the above drawback. The cyclist could adjust the volume or control the song selection using his finger while he is cycling.

### SUMMARY OF THE INVENTION

The primary purpose of the present invention is to provide a music-playing assembly on a motor-bicycle comprising a digital music-playing device, a controlling device and at least one loudspeaker characterized in that the digital music-playing device is mounted at the rear mirror of the motor-bicycle and is connected to the controlling device and the loudspeaker via transmission lines, the controlling device is used to control the digital music-playing device and the loudspeaker to play or produce music.

Yet still another object of the present invention to provide an assembly on a motor-bicycle, the controlling device is mounted at the lateral side of the head of the motor-bicycle and the edge of the left and right handle of the motor-bicycle.

Still yet a further object of the present invention is to provide an assembly on a motor-bicycle, further comprising an amplifier mounted between the digital music-playing device and the loudspeaker, and the amplifier is mounted within the interior of the casing holding the mirror or within the interior of the motor-bicycle hub, the amplifier providing output power to drive the loudspeaker to produce high decibel music.

Another object of the present invention is to provide an assembly on a motor-bicycle, wherein the music-playing will not be misplaced and the controlling by hands allows the user without removing the hands from the handle, and thus, it is not risky in operating the music-playing device while cycling.

Yet still another object of the present invention is to provide an assembly on a motor-bicycle, wherein the loudspeakers are mounted within the rear mirror casing or the interior of motor-bicycle hub which shield the loudspeakers from rain and sun.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a perspective view of the music-playing assembly being mounted onto a motor-bicycle in accordance with the present invention.

FIG. 3 is a perspective view of a second preferred embodiment in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

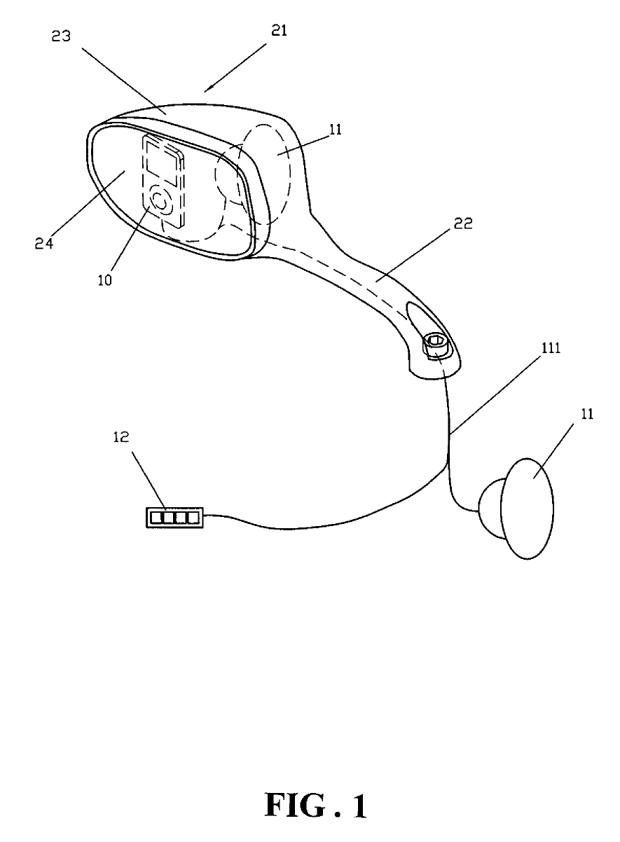

Referring to FIG. 1, there is shown a music-playing assembly of the present invention comprising a digital music-playing device 10, a controlling device 12 and at least one loudspeaker 11.

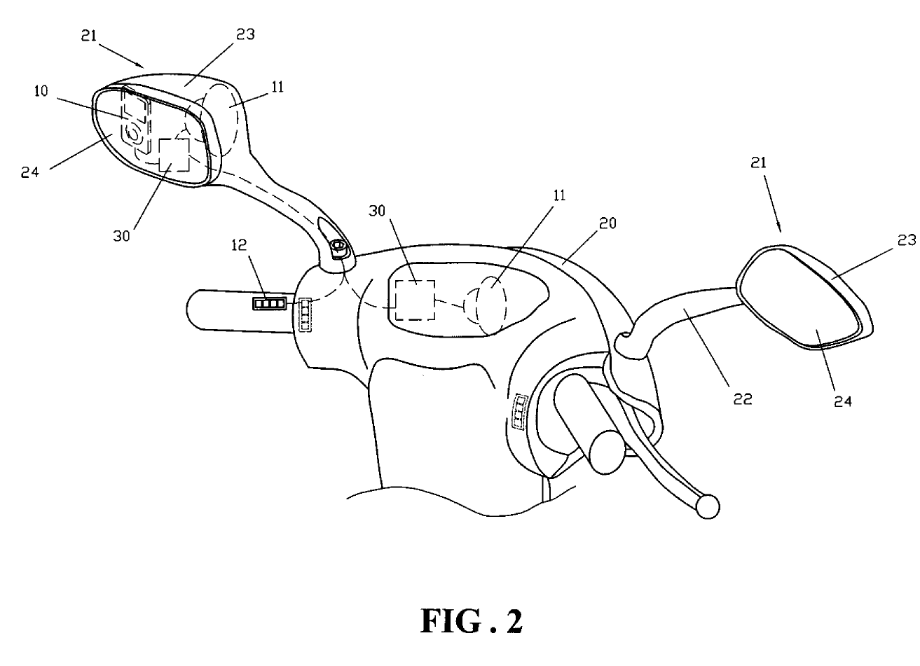

As shown in FIG. 2, the motor-bicycle has a motor-bicycle hub (motor-bicycle body) and at least one rear mirror 2 with a casing. The motor-bicycle is provided with a power supply for use of the motor-bicycle.

In the preferred embodiment of the present invention, two rear mirrors 21 with casing are provided to the handle of the motor-bicycle which is located at the front end of the head portion of the motor-bicycle. The rear mirror 21 has a support 22, a frame body or hub 23 and a mirror 24. The support 22 is mounted at the head of the motor-bicycle 20, and the frame body or hub 23 is interconnected with the free end of the support 22. The mirror 24 is mounted at one lateral side of the frame body 23.

The music-playing assembly utilizes the power supply of the motor-bicycle. The digital music-playing device 10 of the music-playing assembly is mounted within the casing or frame body 23 of the rear mirror, which is fixedly securely or suspended, and transmission lines 111 are used to connect the music-playing device to the controlling device 12 and the loudspeaker 11. The controlling device 12 is mounted at the hub of the head portion of the motor-bicycle, or at the side of the handle of the motor-bicycle. Fingers touch the controlling device 12 to control the music-playing from the device and the loudspeakers 11 are mounted within the casing or hub of the rear mirror, which is at the back of the rear mirror, or any appropriate location within the motor-bicycle.

In application, the stored music of the digital music-playing device 10 is played and is output through the loudspeaker 11. The high decibel of the loudspeaker 11 allows the cyclist to listen even he puts on the helmet.

When the motor-bicycle is stationery, the music-playing device 10 could still provide music via the loudspeaker 11, and the music could be heard around the area. The music-playing device 10 and the loudspeaker are kept or mounted within the casing of the rear mirror, or the loudspeakers are hidden within the motor-bicycle hub, the loudspeakers are waterproof and shielded from sunlight, and hidden from stealing by thief.

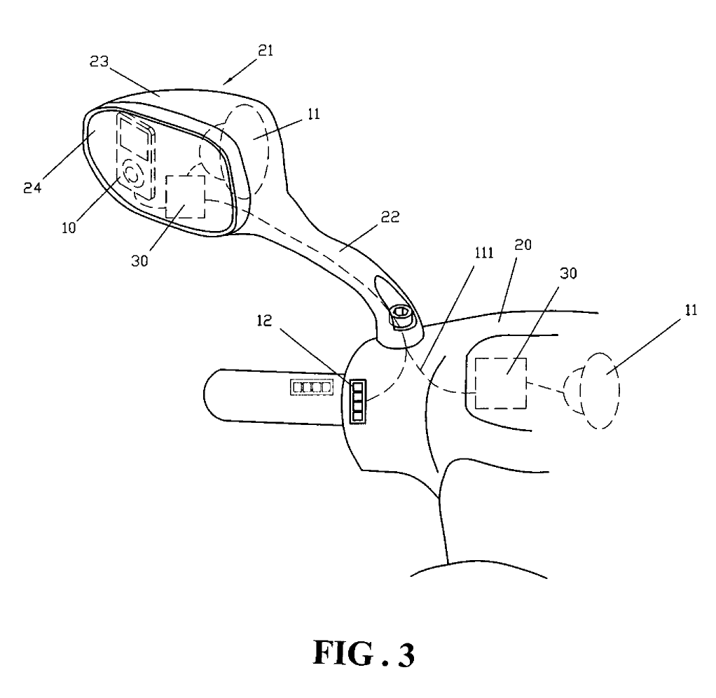

As shown in FIG. 3, there is shown a second preferred embodiment in accordance with the present invention, the mounting of the rear mirror 21, the power supply, the controlling device 12, the digital music-playing and loudspeaker are identical to that of the first preferred embodiment explained above. The controlling device is mounted at the edge of the handle such that the cyclist or the rider does not need to move his hands to control the playing or selection of music or songs.

In accordance with the present invention, an amplifier 30 is mounted in between the digital music-playing device 10 and the loudspeaker 11. Transmission lines 111 are used to connect the amplifier 30 to the digital music-playing device 10 and the loudspeaker 11. The power supply of the motor-bicycle provides power to the amplifier 30, and the amplifier 30 could be mounted at the rear mirror 21, the interior of the motor-bicycle or the storage box at the front or rear of the motor-bicycle. The amplifier 30 is used to drive the loudspeaker 11 if the output power of the music-playing device is insufficient. The amplifier 30 can increase the output power such that the loudspeaker 11 could provide excellent music and songs with sufficient power.

In accordance with the present invention, the music-playing assembly on a motor-bicycle employs a music-playing device, a controlling device and loudspeaker to provide music. The cyclist or rider could control the volume or the selection of music or song while riding or cycling.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A music-playing assembly on a motor-bicycle comprising a digital music-playing device, a controlling device and at least one loudspeaker characterized in that the digital music-playing device is mounted at the rear mirror of the motor-bicycle and is connected to the controlling device and the loudspeaker via transmission lines, the controlling device is used to control the digital music-playing device and the loudspeaker to play or produce music.

2. The music-playing assembly of claim 1, wherein the controlling device is mounted at the lateral side of the head of the motor-bicycle and the edge of the left and right handle of the motor-bicycle.

3. The music-playing assembly of claim 1, further comprising an amplifier mounted between the digital music-playing device and the loudspeaker, and the amplifier is mounted within the interior of the casing holding the mirror or within the interior of the motor-bicycle hub, the amplifier providing output power to drive the loudspeaker to produce high decibel music.
